(19) United States
(12) Patent Application Publication
(10) Pub. No.: US 2020/0262178 A1
(43) Pub. Date: Aug. 20, 2020

(54) PROTECTIVE FILM TAPE

(71) Applicant: Matthew Van Florcke, Amityville, NY (US)

(72) Inventor: Matthew Van Florcke, Amityville, NY (US)

(21) Appl. No.: 16/789,614

(22) Filed: Feb. 13, 2020

Related U.S. Application Data
(60) Provisional application No. 62/806,072, filed on Feb. 15, 2019.

(51) Int. Cl. B32B 7/022; C09J 7/38; B32B 27/08

(52) U.S. Cl. CPC B32B 7/022; C09J 7/38; B32B 2323/10; B32B 2405/00; B32B 27/08

(57) ABSTRACT

Provided therefore herein is a pressure-sensitive adhesive tape for protecting a surface. The pressure sensitive tape includes a material substrate with a coating comprising an ultra high molecular weight polyethylene substance and a silicone substance.

### CROSS-REFERENCE TO RELATED APPLICATIONS

This application claims priority to U.S. Provisional Patent Application No. 62/806,072 filed Feb. 15, 2019 entitled “Protective Film Tape,” the disclosure of which is incorporated by reference herein in its entirety for all purposes.

The present invention relates to a thin tape with high strength and easy releasability to use as a protective layer or coating in a mechanical setting.

### BACKGROUND

Auto mechanics and painters frequently use a form of masking tape, which may be commonly referred to as painter's tape, and which typically have a milder adhesive than conventional masking tape on one side of the tape so that removal of the painter's tape will be facilitated easily. Such tape is typically applied to a wall, automobile, or trim surface so that one edge of the tape is located immediately adjacent to a line of the surface to be painted or otherwise worked on. The applied tape protects the surface to which the tape is applied from the application of paint while the paint is being applied to an adjacent surface. By having a strip of painter's tape protecting the adjacent surface that is not to be painted, the painter can “over paint” the desired surface, allowing the paint to spread on top of the painter's tape. The painter's tape is then removed from the protected surface after the paint has dried to leave a line of the painted surface corresponding to where the painter's tape was located.

Assuming that the painter then needs to paint the surface that had previously been protected, another application of painter's tape can then be applied, after the first painted surface has adequately dried, to the previously painted surface, placing an edge of the painter's tape immediately adjacent the surface to be subsequently painted. The second surface is then painted with paint being “over painted” onto the newly applied painter's tape. After allowing the newly applied paint to dry, the second application of painter's tape can then be carefully removed to expose the two painted surfaces. This dual application of painter's tape is a common practice when painting walls with trim, such as window molding, baseboard or crown molding that is to be painted with a different kind or color of paint than the wall. Another frequent dual application of painter's tape is for the joint between the walls of a room and the ceiling, where the ceiling is to be painted with a different kind or color of paint than the walls.

Painter's tape can be found in varying widths from one inch to six inches with two to four inch widths being most commonly used. The painter's tape is manufactured with a layer of adhesive on one side of the tape, and in some instances can be manufactured with the adhesive only along one edge of one side of the tape. The adhesive can be adjusted with respect to the ability of the adhesive to stick to the wall surface as some surfaces are more sensitive to adhesive pressure. For example, a wall surface that has just been painted within the preceding twenty-four hours would be more likely to be removed with the painter's tape than a wall surface that had been last painted years previously. Accordingly, some painter's tapes are provided with a lightly operative adhesive for sensitive surfaces.

Such tape is usually applied with significant care so that the tape is properly adhered to the surface to be protected from the application of paint or other scratches or abrasions, and so that the line of the painter's tape adjacent to the surface to be painted is straight and properly located, since the removal of the tape creates the paint line for the painted surface. The second application of painter's tape is even more carefully applied to the newly painted surface for the same reasons as the first application of painter's tape, and also because the newly formed paint line needs to be respected with regard to the second application of painter's tape so that there is no gap between the two respective paint lines to be formed with the removal of the second painter's tape application. Accordingly, the time required for the application of the painter's tape is a significant portion of the time spent to paint any corresponding wall surfaces.

U.S. Pat. No. 4,348,440 to Kriozere discloses a backing strip to cover an adhesive strip formed on a pouch, such as an envelope. U.S. Pat. No. 5,098,786 to Hanke provides double faced masking tape, wherein one area on each opposing side of the masking tape is coated with an adhesive. The tape is folded along the midline and the two adhesive coated areas are arranged so that the non-adhesive area of one side is pressed against the adhesive coated portion of the same side. The opposing side is then oriented such that the adhesive side is facing in the same direction as the adhesive portion of the opposing side of the tape. This configuration enables the tape to be easily rolled onto a dispenser and the tape can be used as a single adhesive sided tape or the top, folded portion can be removed to expose a second adhesive side.

Similarly, U.S. Pat. No. 4,582,737 to Torgerson discloses a double surfaced adhesive tape in which two separate rolls of tape are combined onto a single roll with the adhesive coated sides facing each other on the roll so that the combined roll of tape can be stripped off the dispenser with adhesive facing in opposite directions with a small overlap area therebetween. A painter's masking tape is taught in U.S. Pat. No. 6,444,307 to Tuoriniemi, wherein an adhesive portion of the tape is used to mask a surface with a non-stick backing allows the tape to be dispensed from the roll easily to facilitate the application of the masking tape to the surface to be protected.

A mounting hinge tape, disclosed in U.S. Pat. No. 2,096,559, issued on Oct. 19, 1937, to Lester Riley, has adhesive applied to one side of the tape and is folded to permit one half of the tape to be affixed to a support structure, while the other half of the adhesive-coated side is attached to a movable object. The tape permits the movable object to be hingedly mounted to the support surface and moved about the hinge axis defined by the fold line in the tape. In U.S. Pat. No. 1,726,744 to Krug, masking tape is formed with a narrow strip of adhesive on opposing sides of the masking tape, and at opposing edges, so that the tape could be mounted on a support surface while a larger barrier member could be affixed to the outwardly facing adhesive strip on the opposing side of the masking tape.

Ultra high molecular weight polyethylenes have been used in tape because of its low coefficient of friction. U.S. Pat. No. 5,315,788, for example, discloses a low friction tape for movable vehicle glass. The low friction tape is comprised of an ultra high molecular weight polyethylene material, and is adhesively connected to portions of said movable vehicle door glass to isolate said movable vehicle door glass from said glass run channel and provide a low friction surface for engaging said glass run channel to prohibit the generation of glass chatter and noise created by the sliding engagement of said movable vehicle door glass within said glass run channel. Another tape using an ultra high molecular weight polyethylene.

U.S. Patent Publication No. 20140048199 also discloses an adhesive tape including: a reinforcement layer supporting the adhesive tape; a buffer layer formed on one surface of the reinforcement layer and performing a buffering operation; and an adhesive layer formed on one surface of the buffer layer. The reinforcement layer may include at least one of polyethylene terephtalate, polyimde, polyolefine, and polyethylene naphtalate. The buffer layer may include at least one of polyethylene terephtalate, polyimde, polyolefine, and polyethylene naphtalate, and the adhesive layer may include at least one of acryl, silicone, and urethane. It does not include however a high molecular weight polyethylene. CS Hyde sells an ultra high molecular weight bond tape with includes a UHMW polyethylene and an acrylic adhesive.

Despite these attempts to make a high strength tape which easily removes from a surface, there still remains a need for such a product.

### SUMMARY

Provided therefore herein is a pressure-sensitive adhesive (PSA) tape for protecting a surface. The pressure sensitive tape includes a material substrate with an adhesive coating. The material substrate may be an ultra high molecular weight polyethelyne substance, and the adhesive coating may be a silicone substance.

In an embodiment of the pressure-sensitive adhesive tape, the ultra high molecular weight polyetheylene substance of the PSA tape and the silicone substance are mixed together to provide a co-mingled layer. In another embodiment, the pressure-sensitive adhesive tape has a tensile strength of at least 5000 pounds per square inch. In another embodiment, the pressure-sensitive adhesive tape has a tensile strength of at least 6000 pounds per square inch. In another embodiment, the pressure-sensitive adhesive tape has a tensile strength of at least 7000 pounds per square inch.

In another embodiment, the pressure-sensitive adhesive tape of the present invention has a heat distortion resistance of 203 degrees Fahrenheit and a deformation resistance of 6-8%. In another embodiment, the pressure-sensitive adhesive tape has a coefficient of friction of 0.14-0.18. In another embodiment, pressure-sensitive adhesive tape has a first layer of between about 1-10 microns and the second layer is between about 1-10 microns.

A method of making a pressure adhesive tape for protecting a surface comprising gel spinning an ultra high molecular weight polyethylene substance into a film, and coating a silicone substance thereupon is also provided herein.

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### BRIEF DESCRIPTION OF THE DRAWINGS

FIG. 1 shows a cross section of the tape of the present invention.

### DETAILED DESCRIPTION

The present invention provides a pressure-sensitive tape made of a thin high impact strength film and an easily released pressure sensitive silicone adhesive. The tape of the present invention can be made in a variety of widths, and is ideally suited for auto body repair to protect previously painted surfaces from secondary assembly and machining operations which often scratch or scrape the painted surface. The film durability and adhesive release properties is the key to its usefulness, as it allows the tape to be removed without leaving residue or damaging the surface to which it is applied.

An Ultra-high-molecular-weight polyethylene film coupled with a heat resistant silicone adhesive provides a temporary, but durable protective surface. The tape may be applied to protect painted surfaces that are subject to surface scratching, gauging and abrasion. Also, the tape is pliable enough that it can conform to curves and to wrap over edges. The tape will resist inadvertent physical contact damage as well as machining operations resulting from accidental overlapping from the adjacent panel repair.

It has been surprisingly discovered that the unique combination of the present invention is unique from other film tapes in that its ability to protect from hard scuffs and scrapes is a result of its film toughness combined with its thickness. Furthermore, its adhesive characteristics permit direct, prolonged contact with painted finished surfaces without leaving sticky residue or pull off damage to paint.

The tape can be used in a number of applications, including in repairing a vehicle which requires removal of fender to gain access to sub systems e.g. heater valve replacement. Prior to disassembly, tape is applied to edges and surfaces that are susceptible to scraping, scuffing, etc. Panel is safely removed from vehicle and put aside. Work is performed while fender is protected and stored safely. Upon reassembly and alignment of fender it is typical to encounter resistance in simultaneously aligning all attachment points. When a worker is focused visually on a particular area, often scraping and serious paint damage occurs to surfaces and edges that are out of the line of sight and not properly protected. By utilizing the tape of the present invention, a single operator can easily reassemble and align fender without causing damage to the painted surfaces. Furthermore, in vehicle restoration and collision repair, body panels are often painted off the car and will require assembly after the painted surface is applied.

In another embodiment, the tape of the present invention is used in an abrasive machining operation to an adjacent panel, which risks overlap and damage to an undamaged panel. By applying the tape of the present invention to the adjacent panel, protection is provided to ensure abrasive action does not damage existing finish.

In another embodiment, furniture installers, moving personnel, fabricators of various textiles can also benefit from the product. Anywhere a durable surface protection film is required to protect highly finished surfaces, i.e. kitchen cabinets, decorative chrome, etc.

In another embodiment, mechanically mated parts, in static condition, may also benefit from the product. Anywhere a durable temporary barrier may be required to protect against damage to highly finished surfaces, i.e. test fitting automotive panels with fasteners, industrial enclosures, etc.

In another embodiment, when applied to mated parts, in static condition, may also benefit from the product. Anywhere a durable temporary barrier may be required to protect against chafing damage to highly finished surfaces, i.e. transporting subassemblies within a production facility, external to and from subcontractor and downstream processes, shipping to end users, etc.

A pressure sensitive adhesive (PSA) substances can be used to adhere materials to other materials, articles or surfaces, which may include other substrates. Tapes that use PSA substances can be produced in a wide range of forms, such as unsupported adhesive films known as transfer tapes, double sided tapes with a carrier film, tissue, or nonwoven material coated on one or both sides with pressure sensitive adhesives. The adhesive coating is applied to a first substrate, and this adhesive coated substrate can then be applied to a second substrate, so that the second substrate becomes adhesively coated. For example, a PSA resin can be coated onto a release liner and supplied as a roll of PSA tape.

As used herein, the term material substrate refers to any conventional material known in the art to be used as a layer of tape to which an adhesive substance is attached. The material substrate of the present invention may be a woven or extruded plastic film, yarn, or other fibrous material, all well known in the art. Representative examples of materials suitable for the material substrate of this invention include polyolefins, such as polyethylene, including high density polyethylene, low density polyethylene, linear low density polyethylene, and linear ultra low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used. The material substrate can be in the form of single or multi-layer films, non-woven films, porous films, foam-like films, and combinations of the foregoing. Material substrates can also be prepared from filled materials, such as, for example, filled films, e.g., calcium carbonate filled polyolefins. Material substrates are preferably selected from polyethylene and polypropylene films, with the most preferred materials being linear low density and ultra low density polyethylene films.

Material substrates can be made by any known method of film forming, such as, for example, extrusion, co-extrusion, solvent casting, foaming, non-woven technology, and the like. The material substrate can have any thickness so long as it possesses sufficient integrity to be proces sable and handleable, with thicknesses preferably ranging from about 10 micrometers to 500 micrometers.

As used herein, the term “co-mingled” refers to a substantial permeation of one layer by another as the two layers are combined. In an example, an adhesive coating may fluidly permeate some of the porous surface of a material substrate such that the two layers form a tape, or other substance, which has properties that can be unexpectedly different from simple addition of the two layers together. Such properties are further demonstrated in the data contained herein.

As used herein, the term coefficient of friction refers to the ratio between the force necessary to move one surface horizontally over another and the pressure between the two surfaces.

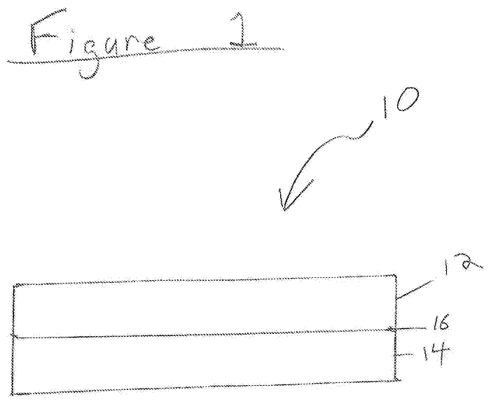

With reference now to the drawings, FIG. 1 shows a cross-section of the pressure-sensitive adhesive tape 10 of the present invention, showing a material substrate 12 and adhesive coating 14 connected at an interface 16.

It is often desirable for the pressure sensitive adhesive tape of the present invention to be assembled in the form of a planetary or other desired roll. When the tape assembly is provided in roll form, the method comprises unwinding the roll to expose the pressure sensitive adhesive of an adhesive side of the adhesive tape assembly, optionally cutting the adhesive tape assembly into discrete sections of desired lengths, and then applying the adhesive tape assembly to a first substrate as described above. Each of the discrete lengths can have a length and a width suitable for adhering a component onto a vehicle, building or other surface.

Ultra-high-molecular-weight polyethylene (UHMWPE, UHMW) is a subset of the thermoplastic polyethylene. Also known as high-modulus polyethylene, (HMPE), it has extremely long chains, with a molecular mass usually between 3.5 and 7.5 million amu. The longer chain serves to transfer load more effectively to the polymer backbone by strengthening intermolecular interactions. This results in a very tough material, with the highest impact strength of any thermoplastic presently made.

UHMWPE is odorless, tasteless, and nontoxic. It embodies all the characteristics of high-density polyethylene (HDPE) with the added traits of being resistant to concentrated acids and alkalis, as well as numerous organic solvents. It is highly resistant to corrosive chemicals except oxidizing acids; has extremely low moisture absorption and a very low coefficient of friction; is self-lubricating (see boundary lubrication); and is highly resistant to abrasion, in some forms being 15 times more resistant to abrasion than carbon steel. Its coefficient of friction is significantly lower than that of nylon and acetal and is comparable to that of polytetrafluoroethylene (PTFE, Teflon), but UHMWPE has better abrasion resistance than PTFE.

UHMWPE is a type of polyolefin. It is made up of extremely long chains of polyethylene, which all align in the same direction. It derives its strength largely from the length of each individual molecule (chain). Van der Waals bonds between the molecules are relatively weak for each atom of overlap between the molecules, but because the molecules are very long, large overlaps can exist, adding up to the ability to carry larger shear forces from molecule to molecule. Each chain is bonded to the others with so many van der Waals bonds that the whole of the inter-molecule strength is high. In this way, large tensile loads are not limited as much by the comparative weakness of each van der Waals bond. When formed into fibres, the polymer chains can attain a parallel orientation greater than 95% and a level of crystallinity from 39% to 75%. In contrast, Kevlar derives its strength from strong bonding between relatively short molecules.

The simple structure of the molecule also gives rise to surface and chemical properties that are rare in high-performance polymers. For example, the polar groups in most polymers easily bond to water. Because olefins have no such groups, UHMWPE does not absorb water readily, nor wet easily, which makes bonding it to other polymers difficult. For the same reasons, skin does not interact with it strongly, making the UHMWPE fiber surface feel slippery. In a similar manner, aromatic polymers are often susceptible to aromatic solvents due to aromatic stacking interactions, an effect aliphatic polymers like UHMWPE are immune to. Since UHMWPE does not contain chemical groups (such as esters, amides or hydroxylic groups) that are susceptible to attack from aggressive agents, it is very resistant to water, moisture, most chemicals, UV radiation, and micro-organisms. Under tensile load, UHMWPE will deform continually as long as the stress is present—an effect called creep.

When UHMWPE is annealed, the material is heated to 135° C. to 138° C. in an oven or a liquid bath of silicone oil or glycerine. The material is then cooled down at a rate of 5° C./h to 65° C. or less. Finally, the material is wrapped in an insulating blanket for 24 hours to bring to room temperature.

As used herein, the term pressure sensitive adhesive is an adhesive which forms a bond when pressure is applied to marry the adhesive with the adherent. No solvent, water, or heat is needed to activate the adhesive. It is used in pressure-sensitive tapes, labels, glue dots, note pads, automobile trim, and a wide variety of other products. As the name “pressure-sensitive” indicates, the degree of bond is influenced by the amount of pressure which is used to apply the adhesive to the surface. Surface factors such as smoothness, surface energy, removal of contaminants, etc. are also important to proper bonding. PSAs are usually designed to form a bond and hold properly at room temperatures. PSAs typically reduce or lose their tack at low temperatures and reduce their shear holding ability at high temperatures; special adhesives are made to function at high or low temperatures.

Pressure-sensitive adhesives (PSA) form a bond by the application of light pressure to marry the adhesive with the adhered. This is in contrast to adhesives which require activation in the form of energy. PSAs are designed to have a balance between flow and resistance to flow. The bond forms because the adhesive is soft enough to flow (i.e., “wet”) to the adhered. The bond has strength because the adhesive is hard enough to resist flow when stress is applied to the bond. Once the adhesive and the adhered are in close proximity, molecular interactions, such as van der Waals forces, become involved in the bond, contributing significantly to its ultimate strength.

PSAs are designed for both permanent and removable applications. Examples of permanent applications include safety labels for power equipment, foil tape for HVAC duct work, automotive interior trim assembly, and sound/vibration damping films. Some high performance permanent PSAs exhibit high adhesion values and can support kilograms of weight per square centimeter of contact area, even at elevated temperatures. Permanent PSAs may initially be removable (for example to recover mislabeled goods) and build adhesion to a permanent bond after several hours or days.

Removable adhesives are used in applications such as surface protection films, masking tapes, bookmark and note papers, barcodes labels, price marking labels, promotional graphics materials, and for skin contact (wound care dressings, EKG electrodes, athletic tape, analgesic and transdermal drug patches, etc.). Some removable adhesives are designed to repeatedly stick and unstick. They have low adhesion, and generally cannot support much weight. Pressure-sensitive adhesive is used in Post-it notes.

Pressure-sensitive adhesives are manufactured with either a liquid carrier or in 100% solid form. Articles are made from liquid PSAs by coating the adhesive and drying off the solvent or water carrier. They may be further heated to initiate a cross-linking reaction and increase molecular weight. 100% solid PSAs may be low viscosity polymers that are coated and then reacted with radiation to increase molecular weight and form the adhesive, or they may be high viscosity materials that are heated to reduce viscosity enough to allow coating, and then cooled to their final form. Major raw material for PSA's are acrylate-based polymers.

Typically a PSA adhesive can be rubber, acrylic, or silicone based. Rubber adhesives can be based on natural or synthetic rubbers and formulated with tackifying resins, oils and anti-oxidants. Rubber is the most cost effective PSA and offers quick stick capability. Rubber adhesive is not recommended for high heat applications.

Acrylic Adhesives are formulated with acrylic polymers and generally have a better long term aging and more resistance to solvents and environmental factors. Acrylic adhesives typically develop a stronger bond than the traditional Rubber adhesive and are able to take higher temperatures.

Silicone adhesives are formulated with Silicone polymers and the only adhesive that will bond well with silicone substrates. Silicone adhesives are relatively expensive and have a very low initial tack, but can withstand higher temperatures than both Rubber and Acrylic adhesive. Silicone adhesives are typically and preferably used in sealant applications as a sealant layer.

UHMW polyethylene tape is typically made with an acrylic adhesive. Acrylic is less expensive and has better adhesion at mid-range temperatures than silicone adhesives. Some silicone rubbers can be bulky or thick in appearance, which can be a disadvantage if hoping to create a discreet look. Silicone rubber also has a high viscosity, resisting the force that allows liquid to flow. This is a disadvantage if using silicone rubber in insulation. This rubber must be vacuumed and degassed to stop bubbles from becoming trapped in the rubber. Silicone rubber can also be resistant to curing (referred to as cure inhibition) if there is contact with substances containing sulfur or clay. Except for liquid silicone rubber, all types of silicone rubber are susceptible to these disadvantages. The present invention has overcome these disadvantages by using silicone in conjunction with UHMW polyethylene.

Examples of suitable pressure sensitive adhesive compositions include silicone-based adhesive compositions. MQ silicone resins are copolymeric silicone resins having R′₃SiO_{1/2} units (M units) and SiO_{4/2} units (Q units). Such resins are described in, for example, Encyclopedia of Polymer Science and Engineering, vol. 15, John Wiley & Sons, New York, (1989), pp. 265 to 270, and U.S. Pat. Nos. 2,676,182; 3,627,851; 3,772,247; and 5,248,739, and incorporated herein. MQ silicone resins having functional groups are described in U.S. Pat. No. 4,774,310, which describes silyl hydride groups, U.S. Pat. No. 5,262,558, which describes vinyl and trifluoropropyl groups, and U.S. Pat. No. 4,707,531, which describes silyl hydride and vinyl groups, each of which is incorporated herein. The above-described resins are generally prepared in solvent. Dried or solventless MQ silicone resins are prepared as described in U.S. Pat. Nos. 5,319,040; 5,302,685; and 4,935,484, and incorporated herein.

MQD silicone resins are terpolymers having R′₃SiO_{1/2} units (M units), SiO_{4/2} units (Q units), and R′₂Si_{2/2} units (D units) as described, e.g., in U.S. Pat. No. 5,110,890 and Japanese Kokai HEI 2-36234, and incorporated herein. MQT silicone resins are terpolymers having R₃SiO_{1/2} units (M units), SiO_{4/2} units (Q units), and RSiO_{3/2} units (T units) (MQT resins).

Commercially available MQ resins include SR-545 MQ resin in toluene available from General Electric Co., Silicone Resins Division (Waterford, N.Y.), MQOH resins which are MQ silicone resins in toluene available from PCR, Inc. (Gainesville, Fla.). Such resins are generally supplied in organic solvent. These organic solutions of MQ silicone resin may be used as is or may be dried by any number of techniques known in the art including, e.g., spray drying, oven drying, and steam separation, to provide a MQ silicone resin at 100 percent non-volatile content. The MQ silicone resin can also include blends of two or more silicone resins. One example of a useful class of silicone polymers is silicone polyurea block copolymers. Silicone polyurea block copolymers include the reaction product of a polydiorganosiloxane diamine (also referred to as silicone diamine), a diisocyanate, and optionally an organic polyamine.

A silicone pressure-sensitive adhesive having high weather resistance may also be used. Examples of the silicone pressure-sensitive adhesive include a peroxide cure type silicone pressure-sensitive adhesive and an addition cure type silicone pressure-sensitive adhesive. Specific examples of the silicone pressure-sensitive adhesive include a silicone pressure-sensitive adhesive obtained from a material containing a silicone gum and a silicone resin. For example, an organopolysiloxane containing dimethylsiloxane as a main structural unit can be used as the silicone gum. For example, an MQ resin containing an M unit of R₃SiO₂ and a Q unit of SiO₂ can be used as the silicone resin.

The Ultra High Molecular Weight Polyethelyne substance utilizies a low-adhesion surface employed to serve as a release coat. The UHMWPE film substrate inherently contains a low enough surface energy to work as release facing. When coupled with the adhesive coating, an ultra low co-efficient of friction is accomplished as tested against Cr-plated steel at 23° C. yielding a coefficient of friction of 0.14-0.18

As used herein, a coefficient of friction refers to the ratio between the force necessary to move one surface horizontally over another and the pressure between the two surfaces. Most dry materials in combination have friction coefficient values between 0.3 and 0.6. Values outside this range are rarer, but teflon, for example, can have a coefficient as low as 0.04. A value of zero would mean no friction at all, which is elusive at best, whereas a value above 1 would mean that the force required to slide an object along the surface is greater than the normal force of the surface on the object.

Friction occurs in two ways: kinetic and static. Kinetic friction acts on an object that slides on a surface, whereas static friction occurs when friction prevents the object from moving. A simple but effective model for friction is that the force of friction, f, is equal to the product of the normal force, N, and a number called the coefficient of friction, μ. The coefficient is different for every pair of materials that contact each other, including a material that interacts with itself. The normal force is the force perpendicular to the interface between two sliding surfaces—in other words, how hard they push against each other.

### EXAMPLES

The present invention is further exemplified, but not limited, by the following representative examples, which are intended to illustrate the invention and are not to be construed as being limitations thereto.

UHMWPE is processed via gel spinning, in which a precisely heated gel of UHMWPE is extruded, drawn through the air and then cooled in a water bath. The result is a fiber with a high degree of molecular orientation, and therefore exceptional tensile strength. The material is then formed into sheets and cut to the desired width. The adhesive is then applied and then rolled into desired length spools. Material Physical properties listed in table one are derived from standardized test data for UHMWPE utilizing industry test methods identified in the column entitled “Test Method”.

TABLE 1

| PROPERTY | TEST METHOD | VALUE |
|---|---|---|
| Peel strength 180° pull | ASTM D903 | <2.0 lbs |
| Tensile strength (PSI) | ASTM-D 882 | 6000 |
| Elongation (%) | ASTM-D 882 | 300 |
| Water Absorption | | 0.01 |
| Density (g/cc) | | 0.93 |
| Heat Distortion (° F.) | ISO R75 Method A | 203 |
| Deformation (%) | 2000 psi, 6 hr., 122° F. | 6-8 |
| Dielectric Strength (V/mil) | ASTM-D 149 | 3000 |
| Dissipation Factor | ASTM-D 150 | 0.0004 |
| Coefficient of Thermal | | ~1.1 × 10⁴ |
| Expansion | | |
| Thermal Conductivity | (73° F.)[BTUin)/(ft²hr ° F.) | 0.44 |

Thickness of the tape may be 0.003″, 0.005″, 0.010″, and 0.020″

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed is:

1. A pressure-sensitive adhesive tape for protecting a surface comprising a material substrate with an adhesive coating, said material substrate comprising an ultra high molecular weight polyethelyne substance, and said adhesive coating comprising a silicone substance.

2. The pressure-sensitive adhesive tape of claim 1 wherein said ultra high molecular weight substance and said silicone substance are mixed together to provide a co-mingled layer.

3. The pressure-sensitive adhesive tape of claim 1 wherein said tape has a tensile strength of at least 5000 pounds per square inch.

4. The pressure-sensitive adhesive tape of claim 1 wherein said tape has a tensile strength of at least 6000 pounds per square inch.

5. The pressure-sensitive adhesive tape of claim 1 wherein said tape has a tensile strength of at least 7000 pounds per square inch.

6. The pressure-sensitive adhesive tape of claim 3 wherein said tape has a heat distortion resistance of 203 degrees Fahrenheit and a deformation resistance of 6-8%.

7. The pressure-sensitive adhesive tape of claim 1 wherein said tape has a coefficient of friction of 0.14-0.18.

8. The pressure-sensitive adhesive tape of claim 1 wherein said material substrate is a polypropylene film.

9. A method of making a pressure adhesive tape for protecting a surface comprising gel spinning an ultra high molecular weight polyethylene substance into a film, and coating a silicone substance thereupon.
